(19) United States
(12) Patent Application Publication
(10) Pub. No.: US 2026/0257421 A1
(43) Pub. Date: Sep. 3, 2026

(54) ADDITIVE MANUFACTURING SYSTEM AND METHOD ADAPTED FOR SIMULTANEOUS HIGH AND LOW ACCURACY BUILD

(71) Applicant: NANOGRANDE INC., Montreal (CA)

(72) Inventors: Juan SCHNEIDER, Laval (CA); Luc JACOB, Mascouche (CA); Steve BOA, Brownsburg-Chatham (CA)

(21) Appl. No.: 19/106,404

(22) PCT Filed: Aug. 25, 2023
(86) PCT No.: PCT/CA2023/051131

§ 371 Date: Feb. 25, 2025

Related U.S. Application Data
(60) Provisional application No. 63/400,888, filed on Aug. 25, 2022.

(51) Int. Cl. B29C 64/273; B29C 64/165; B29C 64/336; B33Y 10/00; B33Y 30/00

(52) U.S. Cl. CPC B29C 64/273; B29C 64/165; B29C 64/336; B33Y 10/00; B33Y 30/00

(57) ABSTRACT

An additive manufacturing system comprises a curing system using LED arrays for curing a binder in low-accuracy zones of the part being manufactured and a laser for joining building particles in high-accuracy zones of the part being manufactured. An associated method comprises pre-determining a low-accuracy building pattern in the low-accuracy zone for curing with the LED arrays and pre-determining a high-accuracy pattern in the high-accuracy zone for joining the building particles with the laser.

### FIELD OF THE INVENTION

The present invention relates to an additive manufacturing system and associated method capable of adjusting its manufacturing process according to the level of accuracy required in the part to be manufactured.

### BACKGROUND

Many additive manufacturing processes have been developed over the years. Some are more adapted to the manufacturing of parts requiring high dimensional accuracy and having a low production volume while others are more adapted to the manufacturing of parts requiring a low dimensional accuracy but relatively high production volumes. For example, binder jetting system (BJS) is a very efficient, fast process while laser additive manufacturing is a slow but very precise way to sinter powders with high resolution. Still, other additive manufacturing systems and methods stand somewhere in between.

Most existing additive manufacturing system and method require a compromise between manufacturing speed and dimensional accuracy. There is therefore a need for a flexible additive manufacturing process requiring less compromise.

### SUMMARY OF THE INVENTION

It is an object of the present invention to provide an additive manufacturing system and method that overcome or mitigate one or more disadvantages of known additive manufacturing systems and methods, or at least provides a useful alternative.

The invention provides the advantages of combining the manufacturing speed typically associated with binder jetting systems with the precision of lasers.

In accordance with an embodiment of the present invention, there is provided an additive manufacturing system comprising a powder bed, an applicator system, a printing system, a first curing system and a laser source. The powder bed has an actuatable build plate therein. The applicator system is operable to form a layer of building material over the build plate. This layer of building material over the build plate has a first zone of building material and a second zone of building material. The printing system has a print head connected to a binder source. The printing system is operable to reach over the building material laid on the build plate apply a binder onto at least the building material in the first zone according to a first predetermined pattern. The first curing system is operable to cure the binder applied to the building material in the first zone. The laser source is operable to join together the building material in the second zone according to a second predetermined pattern.

The laser source may use a first level of energy and a first wavelength adapted to directly weld together the building material along the second predetermined pattern.

Optionally, the printing system may further be operable to apply binder onto the building material in the second zone according to the second predetermined pattern. Then, the laser source is operable to cure, that is to polymerize, the binder applied onto the building material in the second zone using a second level of energy and a second wavelength. The laser source may therefore be operable in an Ultra Violet range of wavelength for polymerizing the binder along the second predetermined pattern in the second zone.

The laser source may also be operable to remove bound building material from a portion of any one of the first predetermined pattern and the second predetermined pattern. The laser source then uses a third level of energy and a third wavelength adapted remove the bound building material.

The laser source may be a pulsed wave laser.

The second predetermined pattern in the second zone may require a higher building accuracy than the first predetermined pattern in the first zone.

The applicator may further comprise a reservoir for receiving a carrier liquid and a belt conveyor. The carrier liquid comprises and carries a solvent and particles of the building material. The belt conveyer is disposed at least partly in the reservoir such that, when the carrier liquid is present in the reservoir, the belt conveyer is at least partly submerged in the carrier liquid and is operable to form a layer made of the carrier liquid. The solvent may comprise a photoinitiator for photo polymerization and UV curing.

In accordance with another embodiment of the invention, there is provided a method of manufacturing a part using the additive manufacturing system described above. The method comprises 1) applying the binder in the first predetermined zone according to the first predetermined pattern using the printing system; 2) curing the binder in the first zone using the first curing system; and 3) joining together the building material along the second predetermined pattern in the second zone using the laser source.

The method may further comprise pre-determining the first predetermined pattern in the first zone; and pre-determining the second predetermined pattern in the second zone, wherein the predetermined pattern in the second zone may require a higher building accuracy than the first predetermined pattern in the first zone.

The joining may comprise directly welding together the building material along the second predetermined pattern by having the laser source use a first level of energy and a first wavelength.

The method of manufacturing may further comprise applying the binder in the second zone according to the second predetermined pattern using the printing system, wherein the joining then comprises curing the binder applied onto the building material in the second zone using the laser source. The method of manufacturing may then comprise operating the laser source at a second level of energy and at an Ultra Violet wavelength range to polymerize the binder along the second predetermined pattern in the second zone.

The method of manufacturing may further comprise using the laser source to removing bound building material from the layer by using a third level of energy and a third wavelength.

A pulsed wave laser may be used as the laser source in the method of manufacture.

Optionally, the method of manufacturing may further comprise 4) forming a second layer of building material over the build plate using the applicator system, the second layer of building material over the build plate having a third zone of building material and a fourth zone of building material; 5) applying the binder in the third predetermined zone according to the third predetermined pattern using the printing system; 6) curing the binder in the third zone using the first curing system; and 7) joining together the building material in the fourth zone using the laser source.

Furthermore, the method of manufacturing may comprise pre-determining the third predetermined pattern in the third zone; and pre-determining the fourth predetermined pattern in the fourth zone, wherein the predetermined pattern in the fourth zone requires a higher building accuracy than the third predetermined pattern in the third zone.

The method of manufacturing may also comprise directly welding together the building material along the fourth predetermined pattern using the laser source.

Alternatively, or complementarily, the method may comprise applying the binder in the fourth zone according to the fourth predetermined pattern using the printing system, wherein the joining comprise using the laser source to cure the binder applied onto the building material in the fourth zone.

Optionally, the method may further comprise adding the particles of the building material to the solvent prior to the applying the binder and forming the layer of building material and solvent using a belt conveyer.

The method of manufacturing may also comprise adding a photoinitiator for photo polymerization and UV curing to the solvent.

### DESCRIPTION OF THE DRAWINGS

These and other features of the present invention will become more apparent from the following description in which reference is made to the appended drawings wherein:

FIG. 1a is a perspective view of an additive manufacturing system in accordance with an embodiment of the present invention;

FIG. 1b is a cross-sectional side view of an additive manufacturing system in accordance with an embodiment of the present invention;

FIG. 2 is microscopic top view of a layer of material made from powder particles having a low size variability and organized in a high-density hexagonal packing arrangement in accordance with an embodiment of the present invention;

FIG. 3 is a microscopic top view of a layer of material made from powder particles prior to being bound with binder in accordance with an embodiment of the present invention;

FIG. 4 is a microscopic top view of the layer of material of FIG. 3 once bound with the binder;

FIG. 5 is a schematical view of a configuration of elements of an additive manufacturing system in accordance with an embodiment of the invention;

FIG. 6 is a top view of an applicator cartridge in accordance with an embodiment of the present invention;

FIG. 7 is a perspective view of the applicator cartridge of FIG. 6;

FIG. 8a is a top view of an inking cartridge in accordance with an embodiment of the invention;

FIG. 8b is a cross-sectional side view of an additive manufacturing system equipped with the inking cartridge of FIG. 8a.

FIG. 9 is a perspective view of a positioner of the inking cartridge of FIG. 8;

FIG. 10 is a perspective view of the inking cartridge of FIG. 8;

FIG. 11 is a perspective view of a holder for receiving either of the applicator cartridge of FIG. 6 or the inking cartridge of FIG. 8 on the additive manufacturing system of FIG. 1 in accordance with an embodiment of the invention;

FIG. 12 is a schematic of a method of manufacturing a part using the additive manufacturing system of FIG. 1.

### DETAILED DESCRIPTION OF THE INVENTION

The present invention relates to an additive manufacturing system and its associated manufacturing method. In particular, the present invention combines the benefits of a two-prong approach in building a part made of layers of powder material: the apparatus and associated method combine the speed of a UV LED array used for polymerizing a binder joining the powder, such as is used in a binder jetting system (BJS), combined with the high precision of a laser which is also used to join the powder particles. The UV LED array is used in regions of the build requiring lower precision while the laser is used in regions of the built requiring higher precision. This system also provides a means to manufacture precise dimensional and smooth surfaces by using the UV LED array and the binder jetting for large areas and a Pulsed wave (PW) laser to ablate the borders of each layer or group of layers, better defining the edges of the layers and reducing possible imperfections created by the diffusion by capillarity of the BJS binder through the layer of powder particles.

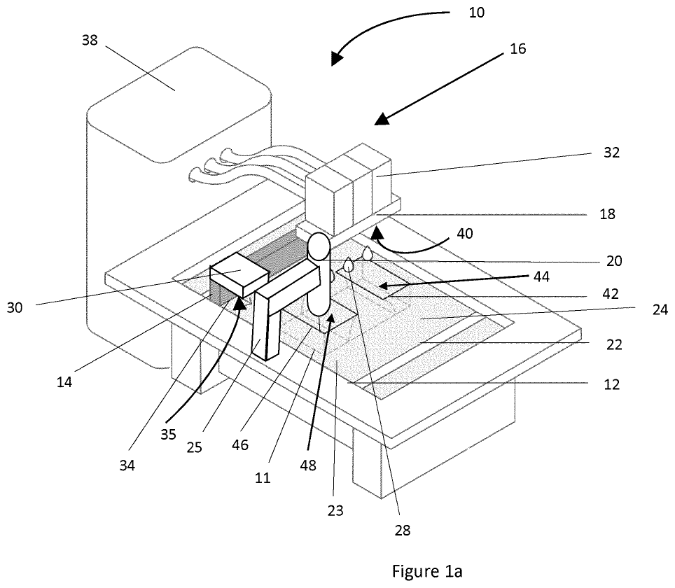

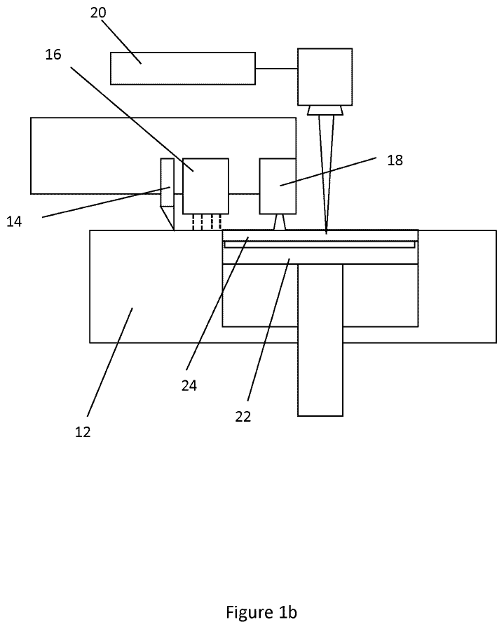

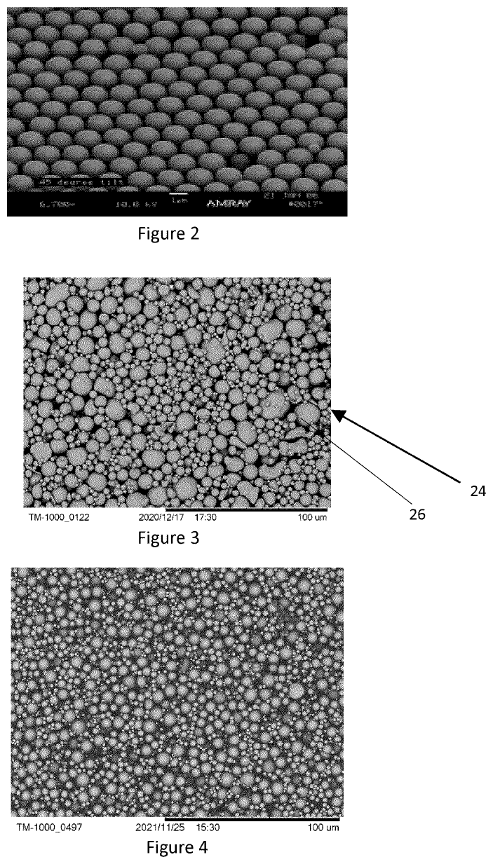

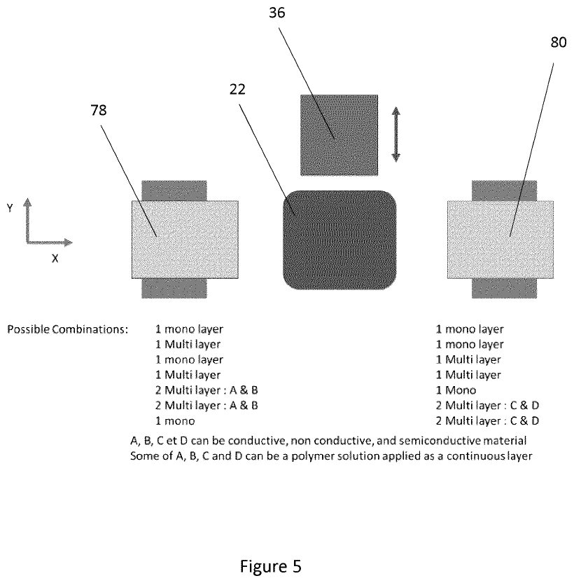

FIGS. 1a and 1b are concurrently referred to. FIG. 1a depicts an additive manufacturing system 10 for manufacturing a part 11. The additive manufacturing system 10 comprises a powder bed 12, a coater system or layer applicator 14 (recoater), a printing system 16, a first curing system 18 and a laser source 20. The powder bed 12 contains an actuatable build plate 22, which moves down in steps as a new layer 23 of a powder material 24 made of particles is laid on the build plate 22. The laser source 20 is mounted by a guiding mechanism, for example a mobile gantry, to the powder bed 12 so as to move in all directions in a plane parallel to that of the build plate 22. The applicator system 14 forms on the build plate 22 a layer 23 of a powder building material 24. An example of such a layer 23 of powder material 24 is shown in FIG. 2, now concurrently referred to, where the layer 23 is made with powder particles 26 of 800 nm diameter. It is possible to observe an hexagonal arrangement of the particles 26, which provides a high-density arrangement of the powder particles 26 since they are of similar size, that is they have a narrow size distribution. FIGS. 3 and 4, now concurrently referred to, depict microscopic views of a typical example of a layer 23 of powder material 24 made from powder particles 26 having a broader size distribution, respectively prior and after being bound with a binder 28.

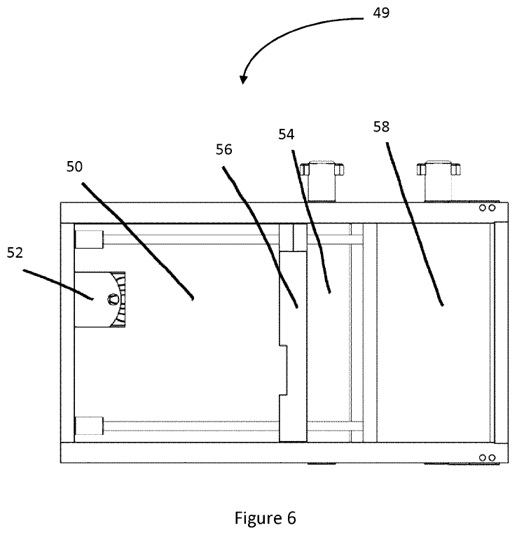

The layer applicator 14 uses one or more interchangeable cartridges 30 containing different powder materials 24. Multiple cartridges 30 may be used simultaneously with the layer applicator 14 allowing the deposition of alternated layers 23 of powder material 24 (hence different powder material types along the Z axis), or even creating a blend between two or more types of powder material 24 on the same layer over the build plate 22 (different types of powder materials along the X and Y axes), all using the same additive manufacturing system 10. This is schematized in FIG. 5, now concurrently referred to.

The layer applicator 14 is provided with a blade 34. The powder material 24, which may be in form of powder or of a paste if pre-mixed with a solvent, is deposited by a dispensing system 35 right in front of the blade 34. The blade 34 is substantially as wide as the build plate 22. The blade 34 is movable vertically to control the height of the powder layer 23 being deposited. The sides of the blade 34 stopping the powder material 24 from spreading beyond the build plate 22. The thickness of the deposited layer 23 may be adjusted from one layer to the next, depending on the space allowed between the last layer and the depositing blade 34.

The paste made of the powder material 24 and of the solvent, also called herein an ink, advantageously allows the spraying of a very thin layer of powder down to approximately 20 micrometers. Indeed, the solvent overcomes repelling forces acting at a microscale on the powder particles, allowing the powder particles 26 to remain close together to be bound by the binder 28.

The dispensing system 35 is equipped with a spraying head which moves from one side to the other of the build plate 22 to spread the powder material 24 laterally while also moving longitudinally in steps, along with the blade, to fill the build plate 22 with the layer of powder material 24. This zig-zag movement allows that a controlled quantity of powder is deposited during the layering formation. It also allows controlling evaporation to minimal while depositing the powder mixed with the solvent in the form of a paste and reduces the left-over amount and powder lost due to excess of powder. The volume of powder material 24 dispensed by the dispensing system 35 may be derived from the thickness of the layer to be built multiplied by the area of the build plate 22.

The dispensing system 35 is equipped with a spraying head which moves laterally along the blade 34. The dispensing system 35 may be mobile so as to move laterally on the blade 34 and so that that the spraying head may spray the powder material 24 across the whole width of the build plate 22, or the dispensing system 35 may be of the same width as the blade 34 and have only the spraying head move across the whole width of the build plate 22 on a lateral displacement mechanism. Such lateral displacement mechanism may be a screw of a carrier actuated by a strap, much like those used on standard inkjet printers.

The layer applicator 14 allows a high level of precision for mono layers of nano-scaled powder particles 26, although the layer applicator 14 is not limited to small particles size as it can be used with several sizes of particles. For parts requiring higher precision, small powder particles may be preferred. The layer applicator 14 may apply layers of powder at different thicknesses, starting from the deposition of a layer having the thickness of a single micrometer-sized particle 26 up to the deposition of a uniform and highly packed layer 23 of particles 26 with a layer thickness larger than the average particle diameter.

A cleaning station and procedure is required to guarantee that the blade 34 is clean and even for each new powder layer 23. A cleaning station 36 also eliminates cross contamination from powder materials of different cartridges 30 as well as undesired accumulation of dried powder material or clump of powder material that hamper the evenness of the new layer being deposited.

The print head 32 is connected to a binder source 38 which feeds the print head 32 with a continuous supply of binder 28. The print head 32 is operable to reach over the powder material 24 laid on the build plate 22 and apply the binder 28 to the powder material 24 according to a predetermined pattern corresponding to the part to be built. The print head 32 is made of a at least one micro nozzle 40, and often a plurality of micro nozzles 40, though which is the binder 28 is sprayed in droplets of at least 1 pL.

The resolution of the print head 32 is limited by a minimal droplet size, the directionality of the print head 32 which is only capable of sending the droplets straight down on the layer of powder 23, and by density of micro nozzles 40 which is possible to install on the print head 32. A 1 pL size of droplet seems to be the practical current limit of droplet size, injecting an volume of binder equivalent to 10×10×10 microns. This 1 pL binder volume creates a larger area than what a focused UV laser beam is capable of attaining. The equation describing the laser spot size is proportional to its wavelength. For example, using an illumination having ultraviolet spectroscopy with a wavelength range of 200-400 nm, and preferably but not limited to 365 nm laser, the spot of this UV laser beam could be as small as 2 to 3 microns diameter, a 100 fold difference compared to the area produced with a 1 to 2 pL droplet of binder 28 on the layer of powder 23 polymerized by the UV LED array. When the laser source 20 is used for polymerization, although the 1 pL droplet spreads in a relatively large area, the laser light only polymerizes the binder 28 where the light reaches, leaving the rest of the area wetted by the binder unpolymerized.

As the binder 28 is applied by the print head 32 on the powder material 24 laid on the build plate 22, the first curing system 18 travels over the build plate 22 to polymerize the applied binder 28 and bind together the powder particles 26 by using a source of UV radiation, such as a UV light or an array of UV diodes. This operation may occur rapidly, especially if the solvent is combined with a photoinitiator, allowing a quick application of a subsequent layer of material particles 26 without disturbing the first surface.

The binder may also cure by solvent evaporation, by heating, or even using a catalyst or chemical reaction. It is also possible to use two different types of binders on the same layer of powder 23, or on different layers of particles 23. For example, depending a first binder may be used in a large area requiring lower accuracy while a second type of binder may be used in a smaller area requiring higher-accuracy. For example, a heat-activated binder could be used in the low-accuracy area while a UV-activated binder could be used in the high-accuracy area (e.g. a 405 nm blue light binder or a double-photon polymerization, giving resolutions below the diffraction limit of light.)

Alternatively, or complementarily to using the first curing system 18, the laser source 20 is used as a second binder curing system along a second pattern in one or more zones of the build plate 32 requiring a higher dimensional precision and accuracy not achievable with the first curing system 18. Indeed, the pattern to be built along the plane of each layer of powder material 24 can be divided into one or more first low-accuracy zones requiring a dimensional accuracy achievable by the first curing system 18 using the UV LEDs and into one or more second zones, or high-accuracy zones, requiring an accuracy which can only be achieved by the second curing system using the laser source 20. This way of predetermining a lower-accuracy predetermined pattern 42 in a low-accuracy zone 44 and a higher accuracy predetermined pattern 46 in a high-accuracy zone 48 allows capitalizing on the respective benefits of each curing system, namely a higher speed of the first UV LED curing system 18 and a higher accuracy of the second curing system using the laser source 20. To polymerize the binder 28 in the high-accuracy zones, the laser source 20 uses a level of energy and a wavelength in the UV range of light adapted to polymerize the binder 28. The laser source 20 can be a pulsed wave PW laser, operating in the Ultra Violet wavelength at which the polymer is sensible for polymerization. Such laser source 20 is capable of following the predetermined high-accuracy pattern 46 in the high-precision zones 48 and polymerize only a precise portion of the applied binder 28 in these zones.

Alternatively, the laser source 20 can be selected or adjusted to an energy level and wavelength adapted to directly weld together the building powder material 24 along the high-precision pattern 46 in the high-precision zones 48. In this case, it is not necessary for the print head 32 to spray the binder 28 on the powder particles of these high-precision zones 48 since they are not joined by polymerizing the binder 28.

The laser source 20 may also be used to remove excess bound building material from any portion of the bound patterns or powder particles 26 in either of the low or high precision zones 48. The laser source 20 then uses a third level of energy and a third wavelength adapted remove the bound building material. For material removal, a high energy and low frequency is required. This can be used to ablate the borders of every bound layer to have a very smooth outer surface and to build a part with additive and subtractive mode. For welding, a low energy and high frequency is required. For polymerization, a continuous light and an energy level at most equal to what the material may absorb is required.

The laser source 20 may be a single tunable laser whose power and wavelength may be adjusted, or two or more laser that are specifically selected for each task. For example, to remove bonded material, weld powder particles 26 and polymerize the binder 28, a single pulsed wave laser may be used by properly adjusting the power and wavelength.

According to another embodiment, it is possible to mix the powder material 24 prior to its deposition on the build plate 22 by the dispensing system 35. In this case, the powder material 24 is pre-mixed with a binding solution such as a photoinitiator, thereby allowing photo polymerization. Such a photoinitiator may be, in a non-limiting example, 1-Hydroxycyclohexylphenylketone (commercially available as Irgacure™ 184), 2,2-Dimethoxy-2-phenyl-acetophenone, 2,2-Diethoxyacetophenone, 2′,4′-Dimethoxyacetophenone, 2-Hydroxy-2-methyl-1-propiophenone (commercially available as Chemcure-73™), 2-Hydroxy-2-methyl-1-phenyl-propanone and any other related and commercially available photoinitiators. Preferably, the composition is based on a blend of acrylate oligomers, one of them being a di-functional and the other being a quatro-functional with excellent LED reactivity. The blend of photoinitiator is part of phosphine oxide family and aromatic ketone.

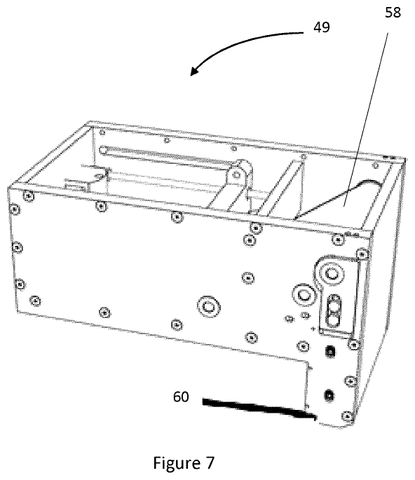

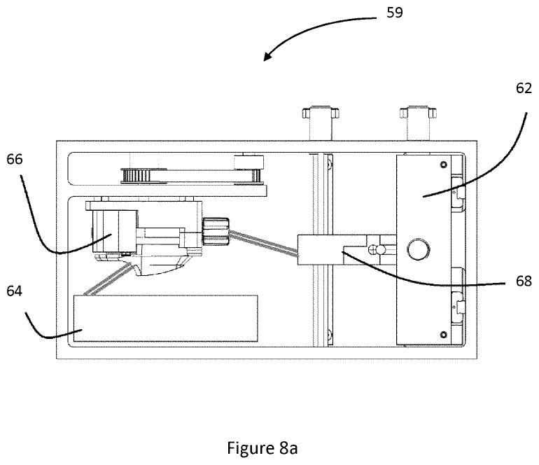

According to another embodiment, the additive manufacturing system 10 required to apply monolayers or multilayers of powder material 24 pre-mixed with a solvent solution is equipped with a layer applicator cartridge 49, a particular model of the general layer applicator cartridge 30. The layer applicator cartridge 49 consists, as illustrated in FIG. 6, in a reservoir 50 filled with liquid, which can be, but not limited to, water or any solvent, on the surface of which the powder particles 26 are injected or deposited or powdered by an applicator head 52. These are then be displaced towards cylinder roller 54 using a moving blade or wall or squeegee 56. FIG. 7 is now concurrently referred to. The roller 54 then moves a monolayer of particles towards a conveyer belt 58 that positions the monolayer from its applicator tip 60 to the deposition surface, such as the build plate 22.

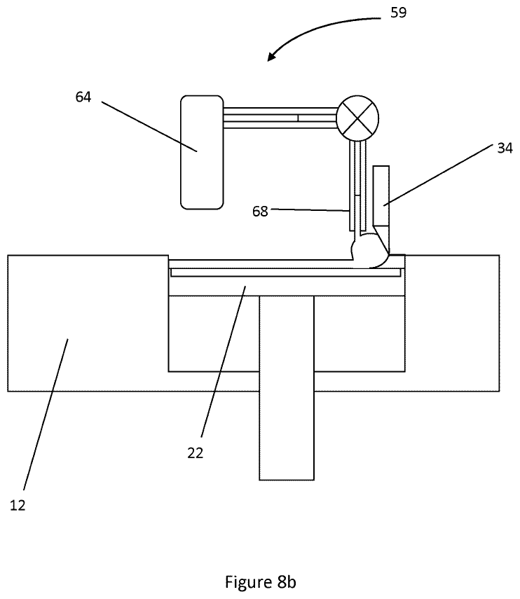

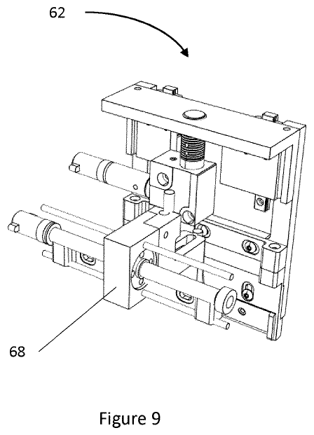

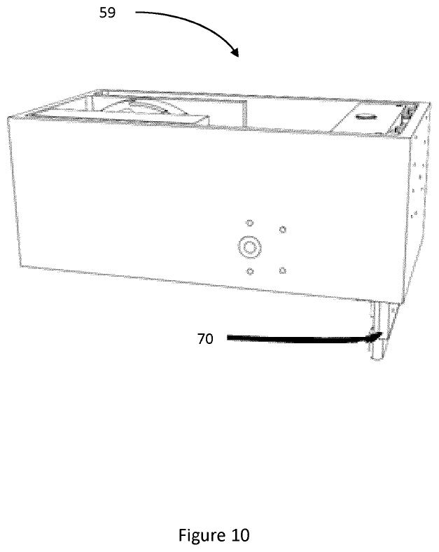

FIGS. 8a and 8b are now concurrently referred to. According to another embodiment, the combined nanoparticles or powder material 24 is mixed with a solvent in the form of a paste or solution which can be applied on the surface of the build plate 22 using an inking cartridge 59 as illustrated in FIG. 8a. This inking cartridge 59, a particular model of the general layer applicator cartridge 30, is equipped with one or more micro nozzles operable to spray droplets of the particle-solvent mixture paste using, for example, piezoelectric elements, mechanical nozzles, or other types of nozzles such as those used in an inkjet printer head. The position of the micro nozzles is controlled by a positioner 62, shown in details in FIG. 9, concurrently referred to. The powder particles 26 are mixed as the particle-solvent paste, or otherwise herein called “ink”, and this material is filled in the reservoir 64 from which it is directed to a peristaltic valve 66 which forwards this ink to a spraying head 68. FIG. 10, now concurrently referred to, illustrates the inking cartridge 59 with its applicator tip 70 through which the ink is delivered.

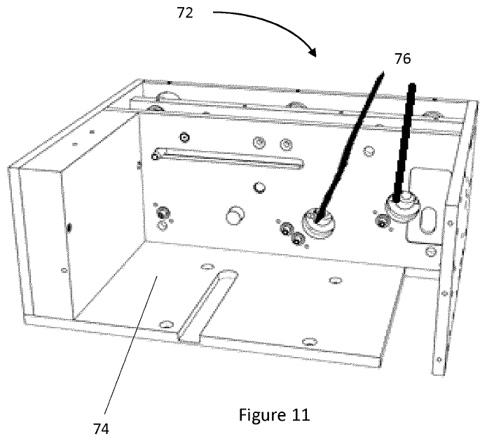

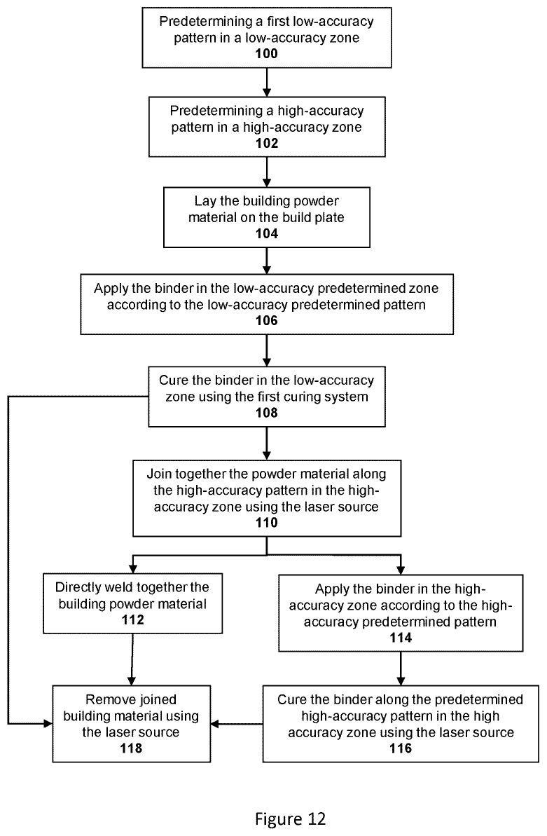

The inking cartridge 59 and the applicator cartridge 49, may be arranged on the additive manufacturing system 10 as schematically represented in FIG. 5. The inking cartridge 59 and the applicator cartridge 49 are easy to replace, clean, maintain, and install in the additive manufacturing system 10 using a holder 72 shown in FIG. 11, now concurrently referred to. Such design prevents problems and risk of contamination currently associated to current paste printing machines. The holder 72 receives both types of cartridges 49, 59 in a receiving area 74. Both types of cartridges 49, 59 are operated through the same mechanical gears 76. The same gear controls both the monolayer and the multilayer applicators.

The roller 54 then moves a monolayer of particles towards a conveyer belt 58 that positions the monolayer from its applicator tip 60 to the deposition surface, such as the build plate 22.

The layer applicator 49 using the conveyer belt 58 can produce ultra-thin films from 20 microns down to 1 nm by depositing a layer of one particle high at a time. This allows building the part with a very fine precision, with the drawback that part takes more time to build. When this level of precision is not required, it may be preferable to use the blade type of applicator found in the inking cartridge 59, which enables the manufacture of thicker layers, having a thickness from around 1 micron and upwards. With this inking cartridge 59, it is possible to lay many layers of small particles at once. For example, a plurality of layers of 5 microns particles could be stacked to build a thicker layer of 30 microns. This allows speeding up the building process of the part.

With these 2 interchangeable applicators, a wide range of thicknesses can be covered, depending on the resolution required and the manufacturing speed in the Z direction (height).

According to another embodiment, as schematically described in FIG. 5, the additive manufacturing system 10, already equipped with a first mono or a multi-layer applicator cartridge 78, is further provided with a 2nd cartridge 80, independently moving from each other along parallel X axes. The cleaning station 36 is also positioned to operate along the same or parallel X axis in order to remove any not sintered or free powder particles from the build plate 22. Each of these optional configuration of the additive manufacturing system 10 may be used in conjunction with the printing system 16, used to spray binder 28, and the laser source 20. In addition, applicator cartridges 49, 59, are operable to deposit more than one type of powder, thereby allowing co-injection in a 3D printing process. Such double assembly allows the application of different layers of particles and different type of particles, co-injection process, in the same 3D printed part. The order of injection is not limited to be used from right to left, application is optional and can work from both possible order based on the desired programming.

FIG. 11, now referred to, depicts a method of manufacturing a part using the additive manufacturing system 10. The method comprises 1) predetermining 100 a low-accuracy pattern 42 in a low-accuracy zone 44 and predetermining 102 a high-accuracy pattern 46 in a high-accuracy zone 46. These steps may be performed when creating a 3D CAD (Computer Aided Design) model of the part to be built, or when this 3D CAD model is processed or sliced as an input for use with by the additive manufacturing system 10. Then, the additive manufacturing system lays 104 the building powder material 24 on the build plate 22 and applies 106 the binder 28 in the predetermined low-accuracy zone 44 following the low-accuracy predetermined pattern 42 using the printing system 16. Then, the binder 28 is cured 108 in the low-accuracy zone 44 using the first curing system 18. Subsequently or simultaneously, the joining 110 together the building powder material 24 occurs along the high-accuracy predetermined pattern 46 in the high-accuracy zone 48 using the laser source 20.

The joining 110 may be achieved through directly welding 112 together the building powder material 24 along the high-accuracy predetermined pattern 46 by having the laser source 20 use a first level of energy and a first wavelength adapted to welding the powder particles 26. This level of energy and wavelength depends on the type of powder material 24 used.

Alternatively, the joining 110 may be achieved through applying 114 the binder 28 along the high-accuracy predetermined pattern 46 in the high-accuracy zone 48 using the printing system 16 and curing 116 the binder 28 applied onto the building powder material 24 along the high-accuracy predetermined pattern 46 in the high-accuracy zone 48 using the laser source 20. The method of manufacturing may then comprise operating the laser source 20 at a second level of energy and at an Ultra Violet wavelength range to polymerize the binder 28 along the high-accuracy predetermined pattern 46 in the high-accuracy zone 48.

To improve the accuracy of either the low-accuracy pattern 42 or the high-accuracy pattern 46, the method of manufacturing may further comprise using the laser source 20 to remove 118 joined building material 24, either bound or welded, from the layer by using a third level of energy and a third wavelength. A pulsed wave laser may be used as the laser source 20 in the method of manufacture.

This method may be repeated as many times as required to build the part layer by layer. Each layer may have different pre-determines low-accuracy and high-accuracy patterns 42, 46 and zones 44, 48.

The present invention has been described with regard to preferred embodiments. The description as much as the drawings were intended to help the understanding of the invention, rather than to limit its scope. It will be apparent to one skilled in the art that various modifications may be made to the invention without departing from the scope of the invention as described herein, and such modifications are intended to be covered by the present description. The invention is defined by the claims that follow.

1. An additive manufacturing system comprising:
a powder bed having an actuatable build plate therein;
an applicator system operable to form a layer of building material over the build plate, the layer of building material over the build plate having a first zone of building material and a second zone of building material;
a printing system having a print head connected to a binder source, the printing system being operable to reach over the building material laid on the build plate, the printing system being operable to apply a binder onto at least the building material in the first zone according to a first predetermined pattern;
a first curing system operable to cure the binder applied to the building material in the first zone; and
a laser source operable to join together the building material in the second zone according to a second predetermined pattern.

2. The additive manufacturing system of claim 1 wherein the laser source uses a first level of energy and a first wavelength adapted to directly weld together the building material along the second predetermined pattern.

3. The additive manufacturing system of claim 1 wherein the printing system is further operable to apply binder onto the building material in the second zone according to the second predetermined pattern, the laser source being operable to cure the binder applied onto the building material in the second zone using a second level of energy and a second wavelength.

4. The additive manufacturing system of claim 1, wherein the laser source is operable to remove bound building material from a portion of any one of the first predetermined pattern and the second predetermined pattern, the laser source using a third level of energy and a third wavelength adapted remove the bound building material.

5. The additive manufacturing system of claim 1, wherein the second predetermined pattern in the second zone requires a higher building accuracy than the first predetermined pattern in the first zone.

6. The additive manufacturing system of claim 1, wherein the laser source is a pulsed wave laser.

7. The additive manufacturing system of claim 1, wherein the laser source is operable in an Ultra Violet range of wavelength for polymerizing the binder along the second predetermined pattern in the second zone.

8. The additive manufacturing system of claim 1, wherein the applicator further comprises:
a reservoir for receiving a carrier liquid carrying a solvent and particles of the building material;
a belt conveyer disposed at least partly in the reservoir such that, when the carrier liquid is present in the reservoir, the belt conveyer is at least partly submerged in the carrier liquid.

9. The additive manufacturing system of claim 8, wherein the solvent comprises a photoinitiator for photo polymerization and UV curing.

10. A method of manufacturing a part using the additive manufacturing system of claim 1, the method comprising:
applying the binder in the first predetermined zone according to the first predetermined pattern using the printing system;
curing the binder in the first zone using the first curing system; and
joining together the building material along the second predetermined pattern in the second zone using the laser source.

11. The method of manufacturing of claim 10, further comprising:
pre-determining the first predetermined pattern in the first zone; and
pre-determining the second predetermined pattern in the second zone,
wherein the predetermined pattern in the second zone requires a higher building accuracy than the first predetermined pattern in the first zone.

12. The method of manufacturing of claim 10, wherein the joining comprise directly welding together the building material along the second predetermined pattern by having the laser source use a first level of energy and a first wavelength.

13. The method of manufacturing of claim 10, further comprising:
applying the binder in the second zone according to the second predetermined pattern using the printing system,
wherein the joining comprise curing the binder applied onto the building material in the second zone using the laser source.

14. The method of manufacturing of claim 13, comprising operating the laser source at a second level of energy and at an Ultra Violet wavelength range to polymerize the binder along the second predetermined pattern in the second zone.

15. The method of manufacturing of claim 10, further comprising:
removing bound building material from the layer by using a third level of energy and a third wavelength using the laser source.

16. The method of manufacturing of claim 11, comprising:
forming a second layer of building material over the build plate using the applicator system, the second layer of building material over the build plate having a third zone of building material and a fourth zone of building material;
applying the binder in the third predetermined zone according to the third predetermined pattern using the printing system;
curing the binder in the third zone using the first curing system; and
joining together the building material in the fourth zone using the laser source.

17. The method of manufacturing of claim 16, further comprising:
pre-determining the third predetermined pattern in the third zone; and
pre-determining the fourth predetermined pattern in the fourth zone,
wherein the predetermined pattern in the fourth zone requires a higher building accuracy than the third predetermined pattern in the third zone.

18. The method of manufacturing of claim 17, further comprising:
applying the binder in the fourth zone according to the fourth predetermined pattern using the printing system,
wherein the joining comprise using the laser source to cure the binder applied onto the building material in the fourth zone.

19. The method of manufacturing of claim 10 further comprising:
adding the particles of the building material to a solvent prior to the applying the binder; and
forming the layer of building material and solvent using a belt conveyer.

20. The method of manufacturing of claim 19, further comprising adding a photoinitiator for photo polymerization and UV curing to the solvent.
